(19) United States
(12) Patent Application Publication
(10) Pub. No.: US 2024/0088657 A1
(43) Pub. Date: Mar. 14, 2024

(54) FRACTIONAL DOMAIN NOISE REDUCTION METHOD FOR POWER SIGNAL

(71) Applicant: SOOCHOW UNIVERSITY, Suzhou (CN)

(72) Inventors: Rong CHEN, Suzhou (CN); Yong YANG, Suzhou (CN); Mingdi FAN, Suzhou (CN)

(21) Appl. No.: 18/019,873

(22) PCT Filed: Sep. 19, 2022
(86) PCT No.: PCT/CN2022/119608

§ 371 Date: Feb. 6, 2023

(30) Foreign Application Priority Data
Aug. 25, 2022 (CN) 202211027163.X

(51) Int. Cl. H02J 3/24; G06F 17/14; H02J 13/00

(52) U.S. Cl. CPC H02J 3/24; G06F 17/14; H02J 13/00002

(57) ABSTRACT

The present application provides a fractional domain noise reduction method for a power signal, including: S1: estimating an optimal fractional Fourier transform angle \hat{α}₀ of an original signal x(t); S2: calculating fractional Fourier transform of the original signal under the optimal fractional Fourier transform angle to obtain X_{\hat{α}}_{₀} (u); S3: performing band-pass filtering in an optimal fractional Fourier transform domain to obtain X_{\hat{α}}_{₀} (u)H(u); S4: calculating fractional Fourier transform of X_{\hat{α}}_{₀} (u)H(u) at an angle of −X_{\hat{α}}_{₀} and S5: judging whether \hat{α}₀ is equal to π/2, if yes, ending the noise reduction, and if no, eliminating a recovered signal component x(t)=x(t)−X_{\hat{α}}_{₀}(u)H(u), and then repeating the steps S1 to S5 again until the estimated optimal FRFT rotation angle is equal to π/2. The present application is not only suitable for a transient stationary disturbance signal, but also suitable for a transient non-stationary disturbance signal, such as linear frequency modulation interference.

### FIELD OF THE DISCLOSURE

The present application relates to the field of power electronic technologies, and particularly to a fractional domain noise reduction method for a power signal.

### BACKGROUND OF THE DISCLOSURE

Large-scale new energy grid connection, extra-high voltage alternating current and direct current transmission and smart power grids develop rapidly, such that power grids present power electronization features in a source link, a grid link and a load link. Application of a large number of power electronic apparatuses and nonlinear loads, such as frequency converters, variable frequency speed control systems, electric vehicle charging devices, or the like, causes serious signal pollution and then causes a power quality (PQ) problem. High quality power system monitoring is increasingly challenging.

Transient power quality disturbance is an important research topic related to power quality in a power system, and has important influences on both a grid side and a user side. Usually, the transient power quality disturbance includes a voltage sag, a voltage swell, a voltage interruption, a transient pulse and transient oscillation disturbance. In order to effectively determine a cause of the disturbance and avoid apparatus damage, effective power quality monitoring has to be implemented. Usually, the power quality monitoring mainly includes the following aspects: noise reduction, feature extraction and classification. In practical application, a power quality signal is often polluted by noise in transmission, measurement and reception processes, such that useful signal features are submerged by the noise, thus affecting subsequent accurate processing and analysis of the signal. Therefore, an effective denoising algorithm is quite important for monitoring and analysis of the power quality. In recent years, a large number of research results, such as noise reduction methods based on algorithms of Fourier transform, wavelet transform, S transform, empirical mode decomposition, or the like, emerge for denoising of the power quality. Although these methods have a good noise reduction effect, in most of the methods, the signal is analyzed and processed in a time domain and a frequency domain. However, with integrated application of a large number of nonlinear fast loads, the transient power quality disturbance and the noise may exhibit non-stationary properties. Different from common transient power quality disturbance, a frequency of non-stationary transient disturbance often changes with time, and energy distribution is not concentrated in the frequency domain, such that the non-stationary transient disturbance and a power frequency signal cannot be effectively separated from the noise.

As extension of the traditional Fourier transform, fractional Fourier transform (FRFT) can characterize the signal in a time fractional frequency domain, thereby realizing respective high accumulation of energy of different signal components. Meanwhile, an FRFT kernel is an orthogonal chirp base, such that the FRFT is quite suitable for processing a non-stationary signal, particularly a linear frequency modulation signal. Furthermore, a discrete FRFT algorithm has a computation speed comparable to that of a fast Fourier transform algorithm. Based on the above advantages, the FRFT can be suitable for noise reduction processing of the non-stationary power quality disturbance. In a prior art, a noise reduction and identification method for a common power quality disturbance signal is researched based on the FRFT algorithm. The prior art initially discusses non-stationary linear frequency modulation interference, but a disturbance signal model is not a transient disturbance model.

### Summary of the Disclosure

In view of this, in order to solve the problem, the present application provides features of a non-stationary transient disturbance signal in a power electronization power system, and then provides a new efficient denoising algorithm for power quality disturbance based on fractional Fourier transform.

A fractional domain noise reduction method for a power signal, comprising:

S1: estimating an optimal fractional Fourier transform angle \hat{α}₀ of an original signal x(t);

S2: calculating fractional Fourier transform of the original signal under the optimal fractional Fourier transform angle to obtain X_{\hat{α}}_{₀}(u);

S3: performing band-pass filtering in an optimal fractional Fourier transform domain to obtain X_{\hat{α}}_{₀} (u)H(u);

S4: calculating fractional Fourier transform of X_{\hat{α}}_{₀} (u)H(u) at an angle of −\hat{α}₀; and

S5: judging whether \hat{α}₀ is equal to π/2, if yes, ending the noise reduction, and if no, eliminating a recovered signal component x(t)=x(t)−X_{\hat{α}}_{₀}(u)H(u) and then repeating the steps S1 to S5 again until the estimated optimal FRFT rotation angle is equal to π/2.

Generally, the present application has the following advantages and user experiences.

The present application provides the improved noise reduction algorithm based on fractional Fourier transform for noise reduction of the transient power quality signal. The method is not only suitable for a transient stationary disturbance signal, such as signals of a voltage swell, a voltage sag, a voltage interruption, or the like, but also suitable for the transient non-stationary disturbance signal, such as linear frequency modulation interference. In the noise reduction process, the linear frequency modulation interference is filtered out from the original power frequency signal as the noise, but can be recovered through fractional inverse Fourier transform, and then, interference signal features are extracted to analyze a cause of disturbance. Furthermore, a method for determining the optimal fractional transform angle is discussed in the present application, and the optimal transform angle can be efficiently determined through one-dimensional peak searching based on the fractional spectrum fourth-order origin moment. Experimental results show that the improved noise reduction algorithm based on fractional Fourier transform can effectively realize noise filtering and retention of transient disturbance positioning information.

### BRIEF DESCRIPTION OF DRAWINGS

FIG. 1 is a block diagram of a traditional signal noise reduction algorithm based on fractional Fourier transform.

FIG. 2 is a flow chart of an improved power signal noise reduction method based on fractional Fourier transform according to the present application.

FIG. 3 is a diagram of energy distribution of a linear frequency modulation signal on a two-dimensional plane (a, u) in the present application.

FIG. 4 is a distribution diagram of a fractional spectrum fourth-order origin moment of the linear frequency modulation signal in the present application.

FIG. 5 is a diagram of waveforms before and after noise reduction and residual noise of a voltage swell signal in the present application.

FIG. 6 is a diagram of waveforms before and after noise reduction and residual noise of a voltage interruption signal in the present application.

FIG. 7 is a waveform diagram of a chirp transient disturbance signal polluted by noise in the present application.

FIG. 8 is a schematic diagram of a noise reduction process of a linear frequency modulation disturbance power signal in the present application.

FIG. 9 is a schematic diagram of root mean square errors of estimated values of beginning and ending moments of transient disturbance under different signal-to-noise ratios in the present application.

### DETAILED DESCRIPTION OF PREFERRED EMBODIMENTS

The present application will be described in further detail with reference to the drawings and embodiments.

In the present application, on the basis of analyzing a common transient disturbance signal, features of a non-stationary chirp-type disturbance signal in a power electronization power system are mainly researched, and then, a novel efficient denoising algorithm for power quality disturbance based on fractional domain analysis is provided.

### 1. Fractional Fourier Transform

Fractional Fourier transform is a general form of Fourier transform, has linear and unitary properties, and is defined as

$${X}_{p} ( u ) = {\int }_{- ∞}^{+ ∞} {K}_{p} ( α ; u ; t ) x ( t ) dt \qquad ( 1 )$$

$${K}_{p} ( α ; u ; t ) = \{ \begin{matrix}\sqrt{\frac{1 - j cot α}{2 π}} \cdot {e}^{j ( \frac{{t}^{2} + {u}^{2}}{2} cot α - ut csc α )} & α \neq n π \\ δ ( t + u ) & α = ( 2 n + 1 ) π \\ & \\ δ ( t - u ) & α = 2 n π\end{matrix} \qquad ( 2 )$$

wherein p is an FRFT order, α is an included angle between an FRFT axis and a time axis, α=pπ/2, Kₚ(α; u; t) is a kernel function of fractional Fourier transform, and n is an integer.

Assuming that a frequency of a signal x(t) is f(t), a frequency change rate thereof can be defined as

$$μ = \frac{d f ( t )}{d t} \qquad ( 3 )$$

According to a definition of the FRFT, it may be derived that an optimal transform angle of x(t) in a fractional domain can be obtained from the frequency change rate thereof; that is,

α₀=−arccot(β) (4)

Under the optimal transform angle, the signal x(t) can realize optimal energy accumulation in the fractional domain; that is, |X_{α}(u)|² takes a maximum value.

### 2. Power Quality Noise Reduction Algorithm Based on Fractional Fourier Transform

### 2.1 Traditional Algorithm

A noise-polluted power quality signal can form different degrees of energy accumulation in different fractional domains according to different transform angles. In order to filter out the noise to the maximum extent, the signal is required to be transformed into the optimal fractional domain to form the optimal energy accumulation.

It is assumed that the noise-polluted power quality signal is represented as

x(t)=s(t)+d(t)+n(t) (5)

wherein s(t) is a power frequency signal, d(t) is a transient disturbance signal, and n(t) is white Gaussian noise.

Since disturbance signals, such as a voltage sag, a voltage swell, a voltage interruption, or the like, only change amplitude of the power frequency signal within a period of time and have no influence on the frequency change rate thereof, the fractional domain where such disturbance signals acquire the optimal energy accumulation is consistent with that for the power frequency signal. The signal may be subjected to the optimal fractional Fourier transform to obtain

X_{α}_{₀ₛ}(u)=S_{α}_{₀ₛ}(u)+D_{α}_{₀ₛ}(u)+N_{α}_{₀ₛ}(u) (6)

wherein α₀ₛ is the optimal fractional domain transform angle of s(t), and Xα_{0,s} (u), Sα₀ₛ(u), Dα₀ₛ(u) and Nα₀ₛ(u) are FRFT results of signals x(t), s(t), d(t) and n(t) at the optimal transform angle respectively. Since the Gaussian white noise cannot form energy accumulation in the fractional domain, a band-pass filter H(u) can be used to separate the signal from the noise in the optimal fractional transform domain of the signal, thereby obtaining

X′_{α}_{₀ₛ}(u)=H(u)S_{α}_{₀ₛ}(u)+H(u)+H(u)N_{α}_{₀ₛ}(u) (7)

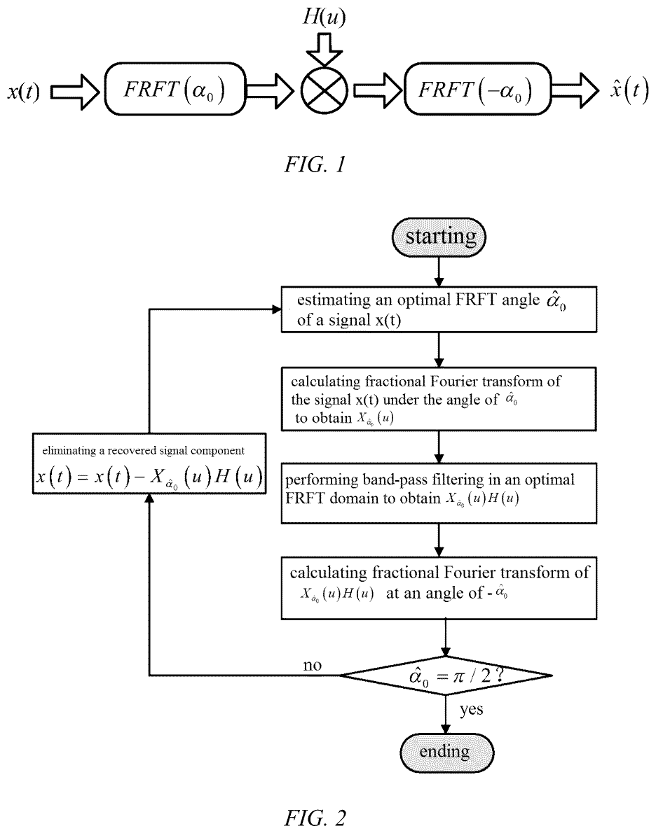

Then, fractional Fourier transform of an angle of —α₀ₛ (i.e., fractional inverse Fouriertransform) is performed on X′α₀ₛ (u) to obtain a noise-reduced signal \hat{x}(t). FIG. 1 shows a block diagram of a traditional signal noise reduction algorithm based on fractional Fourier transform.

### 2.2 Improved Algorithm

From the analysis in section 2.1, when the disturbance signal and the power frequency signal have the same modulation frequency, the optimal fractional transform angles of the two signals are consistent, and the traditional algorithm based on fractional Fourier transform can effectively achieve the noise reduction function. However, in the power electronization power system, with application of a large number of non-linear and fast loads, the power quality disturbance may exhibit a non-stationary behavior; that is, the frequency of the disturbance signal cannot be kept constant within an observation period, and with a transient linear frequency modulation disturbance signal as an example, transient non-stationary disturbance may be defined as

d(t)=A·(u(t−t₁)−(t−t₂))·exp(j2πf₁t+jπkt²) (8)

wherein A is amplitude of the disturbance signal, u(t) is a unit step signal, t₁ and t₂ are beginning and ending moments of the disturbance signal, f₁ is a beginning frequency of the linear frequency modulation disturbance signal, and k is the modulation frequency thereof.

Since the modulation frequency of the linear frequency modulation disturbance signal is not 0, the optimal fractional Fourier transform angle thereof is not consistent with that of the power frequency signal any more, and a plurality of energy accumulation peaks are presented in the fractional domain. In this case, the traditional noise reduction algorithm based on FRFT is no longer applicable. In order to solve the problem, two cases can be discussed based on a magnitude relationship of energy peaks of the power frequency signal and the disturbance signal.

(1) The energy peak of the power frequency signal is greater than the energy peak of the disturbance signal. Since the modulation frequency of the power frequency signal is 0, that is, the optimal FRFT angle thereof α₀ₛ is equal to π/2, if the estimated optimal fractional Fourier transform angle is equal to λ/2, the traditional noise reduction algorithm can be directly applied to filter out the non-stationary disturbance with the modulation frequency not equal to zero and the Gaussian white noise. If features of the transient non-stationary disturbance signal are required to be further analyzed, the power signal obtained after noise reduction can be eliminated from the original signal, and the noise reduction algorithm based on FRFT is further implemented on the residual signal, such that the transient disturbance can be reconstructed.

(2) The energy peak of the power frequency signal is less than the energy peak of the disturbance signal. At this point, an optimal FRFT rotation angle of the non-stationary disturbance signal d(t) is estimated first. An estimated value d′(t) of the non-stationary disturbance signal may be obtained using the band-pass filter and fractional inverse Fourier transform. Then, d′(t) is eliminated from the original signal x(t), and the FRFT noise reduction algorithm is applied again to x′(t)=x(t)−d′(t) until the estimated optimal FRFT rotation angle is equal to π/2. Relevant features of the transient disturbance can be obtained by analyzing d′(t).

FIG. 2 shows a flow chart of an improved power signal noise reduction algorithm based on fractional Fourier transform, which includes the following steps:

S1: estimating the optimal fractional Fourier transform angle \hat{α} ₀ of the original signal

S2: calculating the fractional Fourier transform of the original signal under the optimal fractional Fourier transform angle to obtain X_{α}_{₀}(u);

X_{α}_{₀}(u)=S_{α}_{₀}(u)+D_{α}_{₀}(u)+N_{α}_{₀}(u)

wherein X_{α}_{₀}(u), S_{α}_{₀}(u), D_{α}_{₀}(u) and N_{α}_{₀}(u) are the FRFT results of the signals x(t), s(t), d(t) and n(t) at the optimal transform angle respectively.

S3: performing band-pass filtering in an optimal fractional Fourier transform domain to obtain X_{α}_{₀}(u)H(u).

S4: calculating fractional Fourier transform of X_{α}_{₀}(u)H(u), at an angle of −\hat{α}₀.

S5: judging whether \hat{α}₀ is equal to π/2, if yes, ending the noise reduction, and if no, eliminating a recovered signal component x(t)=x(t)−X_{\hat{α}}_{₀}(u)H(u), and repeating the steps S1 to S5 again until the estimated optimal FRFT rotation angle is equal to π/2.

### 2.3 Estimation Method of Optimal Fractional Fourier Transform Angle

From the analysis in section 2.2, the noise reduction algorithm based on fractional Fourier transform requires processing of the signal in its optimal fractional transform domain. Therefore, a way to estimate the optimal fractional transform angle of the signal is crucial to a performance of the noise reduction algorithm. Usually, the optimal transform angle of the FRFT is obtained by searching for a peak on a two-dimensional plane formed by the fractional transform domain (u) and a transform angle domain (a), and the process can be expressed as

$$\{ {\hat{α}}_{0} , {\hat{u}}_{0} \} = arg {max}_{α , u} {\vert {X}_{α} ( u ) \vert}^{2} \qquad ( 9 )$$

wherein â₀ is an estimated value of the optimal transform angle and û₀ is a coordinate corresponding to the energy peak on the optimal transform domain.

Clearly, a two-dimensional peak search results in considerable computational complexity. To solve this problem, a second-order FRFT central moment is proven to be useful for fast acquisition of the optimal transform angle based on an ambiguity function. However, the second-order FRFT central moment is quite sensitive to the noise and do not perform as well as a fourth-order FRFT central moment. Further considering calculation complexity, a fractional spectrum fourth-order origin moment is more excellent.

The fractional spectrum fourth-order origin moment of the signal x(t) is defined as

η(α)=∫_{-∞}^{+∞}|Xₚ(u) |⁴du (10)

The optimal transform angle can be estimated as

$${\hat{α}}_{0} = arg {max}_{α} η ( α ) \qquad ( 11 )$$

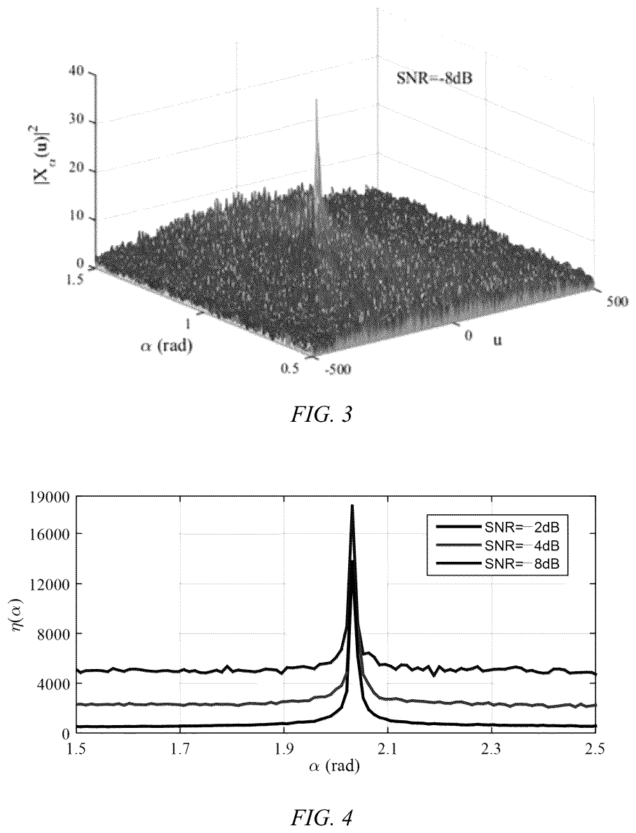

FIGS. 3 and 4 show the energy distribution |X_{α}(u)|² of the linear frequency modulation signal on the two-dimensional plane (α, u) and the distribution of the fractional spectrum fourth-order origin moment η(α) thereof on a one-dimensional plane (α) respectively.

Compared with the two-dimensional peak search, the optimal fractional Fourier transform angle can be determined through a one-dimensional search according to the fractional spectrum fourth-order origin moment of the signal, thereby greatly improving a calculation efficiency. Furthermore, it can be seen from FIG. 4 that the fractional spectrum fourth-order origin moment at different transform angles in signal-to-noise ratio transform increases as a whole with an increase of the noise. Therefore, the fractional spectrum fourth-order origin moment has a good anti-noise performance, and is used as an estimation algorithm of the optimal transform angle in the present application.

### 2.4 Selection of Fractional-domain Band-pass Filter

After the optimal fractional transform angle is determined, band-pass filtering is carried out on the signal component in the optimal fractional transform domain, which is an important step for eliminating influences of the noise and the non-stationary disturbance signal, and obviously, a performance of the band-pass filter directly influences the noise reduction effect. Therefore, it is necessary to design suitable band-pass filters according to different window function performances. Common window functions mainly include a rectangular window, a Hanning window, a Hamming window, a Blackman window, or the like, and their performances are shown in table 1.

TABLE 1
Typical window function spectral characteristics

| | | Main lobe and side | Decay rate of |
|---|---|---|---|
| Window | Main lobe | lobe maximum | side lobe |
| function | width | peak level (dB) | peak |
| Rectangular | 4π/N | −13 | −6 |
| window | | | |
| Hanning | 8π/N | −31 | −18 |
| window | | | |
| Hamming | 8π/N | −41 | −6 |
| window | | | |
| Blackman | 12π/N | −57 | −18 |

In order to reduce signal energy loss as much as possible and meanwhile effectively filter out noise interference, it is desirable that the main lobe width of the window function is narrow and side lobe amplitude thereof can be decayed as quickly as possible when the filter is designed. However, it is difficult for the general window function to simultaneously satisfy the performance requirements in the above two aspects, and in engineering application, comprehensive consideration is required according to an actual situation. The comparison shows that although the main lobe width of the Hanning window is 2 times that of the rectangular window, the main lobe and side lobe maximum peak and the side lobe peak decaying performance thereof are obviously superior to those of the rectangular window, the comprehensive performance is relatively optimal in the common window functions, and therefore, the band-pass filter in the fractional domain is designed using the Hanning window in the present application, and then, the performance of the noise reduction algorithm is verified.

### 3. Simulation Experiment

In order to verify the performance of the algorithm, simulation experiments are carried out on three power quality problems of the voltage swell, the voltage interruption and the non-stationary transient disturbance (taking the transient linear frequency modulation interference signal as an example) in an MATLAB environment. A signal sampling frequency is 15 kHz, a fundamental wave frequency is 50 Hz, and the Hanning window is selected as the band-pass filter. A signal-to-noise ratio (SNR) is defined to evaluate the noise reduction effect, as shown in equation (12).

$$S N R = 10 lg \{ \frac{\sum {s ( t )}^{2}}{\sum {[ s ( t ) - {s}^{′} ( t ) ]}^{2}} \} \qquad ( 12 )$$

wherein s(t) and s′(t) are a signal before noise pollution and a recovered signal obtained after noise reduction respectively.

### 3.1 Noise Reduction Process and Signal-to-noise Ratio Analysis

### 3.1.1 Voltage Swell Signal Noise Reduction Experiment

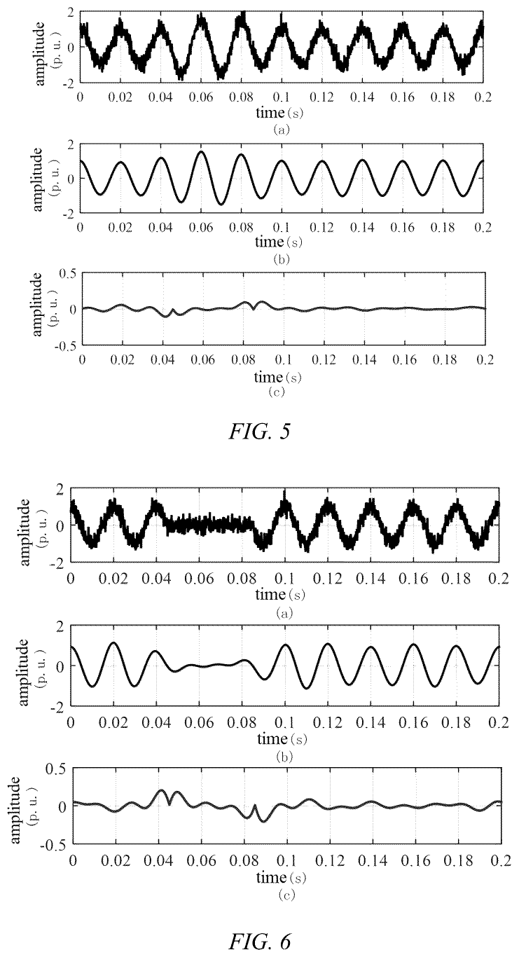

The improved noise reduction algorithm based on fractional Fourier transform is adopted for a voltage swell signal with an input signal-to-noise ratio of 10 dB, and waveforms thereof before and after the noise reduction and the residual noise are shown in FIG. 5. From FIGS. 5(a) and (b), the signal waveform after the noise reduction is smoother, the features of the original signal are better preserved, and an output signal-to-noise ratio is improved to 21.35 dB. An ordinate range is further reduced to observe the residual noise, and as shown in FIG. 5(c), it can be found that waveform fluctuation is large near moment points of 0.045 s and 0.085 s when the voltage swell occurs, and an influence of the noise reduction algorithm on a positioning result is required to be further discussed later.

### 3.1.2 Voltage Interruption Signal Noise Reduction Experiment

FIG. 6 shows a noise reduction result of a voltage interruption signal at an input signal-to-noise ratio of 10 dB. Similarly, the noise is effectively filtered out, the features of the power quality signal are reserved, and the output signal-to-noise ratio is improved to 19.21 dB. The residual noise is flat as a whole, but the waveform still fluctuates greatly near voltage interruption moments of 0.045 s and 0.085 s.

From simulation results of FIGS. 5 and 6, it can be seen that the improved algorithm can effectively reduce the noise of the power signal.

### 3.1.3 Non-stationary Transient Disturbance Noise Reduction Experiment

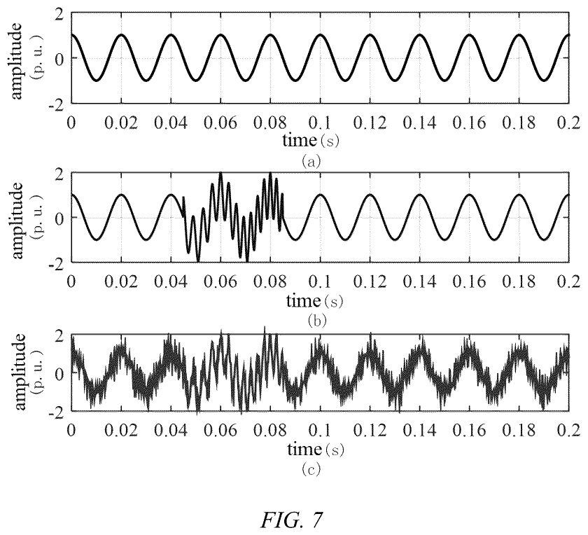

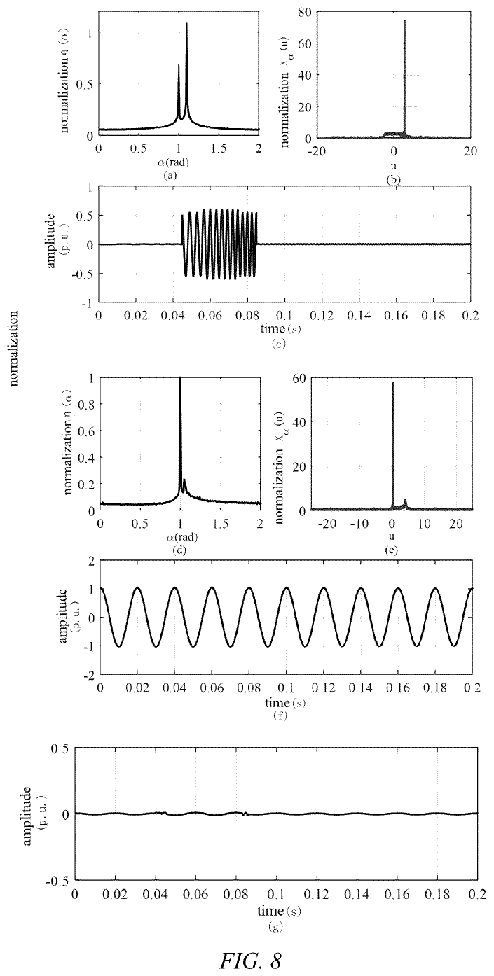

A simulation result for the non-stationary transient disturbance is shown in FIGS. 7 and 8. First, FIG. 7(a) shows an original power frequency signal, FIG. 7(b) shows a power signal containing transient linear frequency modulation interference, FIG. 7(c) shows a power signal polluted by noise, and a signal-to-noise ratio is 10 dB.

To estimate the optimal fractional transform angle, the normalized fractional spectrum fourth-order origin moment of the signal is calculated, and the result is shown in FIG. 8(a). Obviously, at this point, the energy peak of the power frequency signal is less than the energy peak of the disturbance signal. The optimal FRFT angle of the linear frequency modulation disturbance signal d(t) at this point is 1.099 rad by the one-dimensional peak search, and fractional Fourier transform is performed at this angle to obtain the energy distribution in the fractional domain, as shown in FIG. 8(b). An estimated value d′(t) of the linear frequency modulation disturbance signal may be obtained using the band-pass filter and fractional inverse Fourier transform, as shown in FIG. 8(c). Then, d′(t) is eliminated from the original signal x(t), and the FRFT noise reduction algorithm is applied again to the residual signal x′(t)=x(t)−d′(t). FIG. 8(d) shows the normalized fractional spectrum fourth-order origin moment of x′(t), FIG. 8(e) shows the fractional Fourier transform result of the optimal transform angle, FIG. 8(f) shows the power frequency signal recovered by the noise reduction, and FIG. 8(g) shows the residual noise.

It can be seen from the above experiment that the modulation frequency of the transient linear frequency modulation disturbance is different from that of the power frequency signal. When the energy thereof is large, reconstruction and elimination can be first performed using the noise reduction algorithm, and then, the noise reduction can be carried out on the power frequency signal without interference. After the noise reduction, the residual noise is flat as a whole, but still fluctuates slightly at beginning and ending moments of the interference signal. Furthermore, the non-stationary transient disturbance signal is reconstructed, which is beneficial to further extraction of feature parameters of the signal subsequently.

When the input signal-to-noise ratio is changed from 10 dB to 20 dB, the improved algorithm according to the present application and a discrete wavelet transform (DWT) method are adopted to denoise the voltage swell, the voltage interruption and the linear frequency modulation interference. A db6 wavelet is selected as a mother wavelet and two-grade decomposition and soft thresholding are performed. Table 2 gives comparison of the output signal-to-noise ratios.

TABLE 2
Comparison of output signal-to-noise ratio results
after the two noise reduction algorithms are applied
when the input signal-to-noise ratio changes

| | | Output signal-to-noise ratio (dB) | |
|---|---|---|---|
| Signal | Input signal-to- | Method based | Improved method |
| type | noise ratio (dB) | on DWT | based on FRFT |
| Voltage | 10 | 20.67 | 21.35 |
| swell | 15 | 26.43 | 26.38 |
| | 20 | 32.01 | 32.87 |
| Voltage | 10 | 17.64 | 19.21 |
| interruption | 15 | 22.88 | 24.72 |
| | 20 | 26.59 | 28.19 |
| Linear | 10 | 18.72 | 23.35 |
| frequency | 15 | 24.95 | 28.91 |
| modulation | 20 | 27.82 | 31.33 |

It can be seen that the processing results of the voltage swell power signal using the two methods are relatively close, and for the voltage interruption and linear frequency modulation interference, the performance of the improved algorithm according to the present application is superior to that of the traditional wavelet transform algorithm.

### 3.2 Analysis of Performance of Positioning of Beginning and Ending Moments of Transient Disturbance

During power quality signal processing, positioning of the beginning and ending moments of the transient disturbance is important research content. However, after the noise reduction is performed on the power signal, positioning information is often filtered out or weakened. Therefore, whether the positioning information can be effectively retained is an index for evaluating the performance of the noise reduction algorithm. The improved algorithm based on FRFT is adopted to perform noise reduction on the power signals containing the voltage swell, the voltage interruption and the non-stationary transient disturbance, discrete wavelet transform processing is then performed on the power signals containing the voltage swell and the voltage interruption after noise reduction and the reconstructed non-stationary transient signal, the beginning and ending moments of the transient disturbance are obtained according to detail coefficients, and the result is shown in table 3. The input signal-to-noise ratio of the power signal is 10 dB, a theoretical value of the beginning moment of each type of transient disturbance is t₁=0.045 s, a theoretical value of the ending moment is t₂=0.085 s, t′₁ and t′₂ are detection estimated values, and Δt₁ and Δt₂ are estimation errors.

TABLE 3
Detection result of beginning and ending
moments of transient disturbance signal

| | | |
|---|---|---|
| Signal | Detection value/s | Error/s |

| Type | t′₁ | t′₂ | Δt₁ | Δt₂ |
|---|---|---|---|---|
| Voltage | 0.0447 | 0.0855 | 0.0003 | 0.0005 |
| swell | | | | |
| Voltage | 0.0448 | 0.0841 | 0.0002 | 0.0001 |
| interruption | | | | |
| Linear | 0.0447 | 0.0847 | 0.0003 | 0.0003 |
| frequency | | | | |
| modulation | | | | |

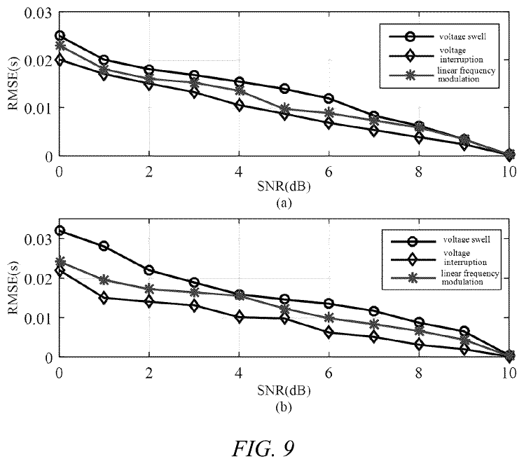

When the signal-to-noise ratio changes, the effect of positioning of the beginning and ending moments of the signal processed using the noise reduction algorithm is further discussed. The signal-to-noise ratio changes from 0 dB to 10 dB, 100 Monte Carlo simulations are performed for each signal-to-noise ratio, FIG. 9(a) shows a root mean square error value of measured values of the beginning moment of the disturbance under different signal-to-noise ratios, and FIG. 9(b) shows a root mean square error value of measured values of the ending moment of the disturbance under different signal-to-noise ratios.

Experimental results show that after the noise reduction algorithm according to the present application, information of the beginning and ending moments of the transient disturbance signal is well reserved, and accurate positioning can be performed.

### 4. Conclusion

The present application provides the improved noise reduction algorithm based on fractional Fourier transform for noise reduction of the transient power quality signal. The method is not only suitable for a transient stationary disturbance signal, such as signals of a voltage swell, a voltage sag, a voltage interruption, or the like, but also suitable for the non-stationary transient disturbance signal, such as transient linear frequency modulation interference. In the noise reduction process, the non-stationary transient disturbance can be effectively reconstructed, thus facilitating the extraction of the disturbance signal features and analysis of the cause of the disturbance. Furthermore, a method for determining the optimal fractional transform angle is discussed in the present application, and the optimal transform angle can be efficiently determined through one-dimensional peak searching based on the fractional spectrum fourth-order origin moment. Experimental results show that the improved noise reduction algorithm based on fractional Fourier transform can effectively realize noise filtering and retention of transient disturbance positioning information.

1. A fractional domain noise reduction method for a power signal, comprising:
S0: providing a power electronization power system;
S1: estimating an optimal fractional Fourier transform (FRFT) angle \hat{α}₀ of an original signal x(t), t representing a time domain;
S2: calculating fractional Fourier transform of the original signal x(t) under the optimal fractional Fourier (FRFT) transform angle to obtain X_{\hat{α}}_{₀}u, u representing a fractional Fourier domain frequency;
S3: performing band-pass filtering in an optimal fractional Fourier transform domain to obtain X_{\hat{α}}_{₀}, uHu;
S4: calculating fractional Fourier transform of X_{\hat{α}}_{₀}u H u at an angle of −\hat{α}₀;
S5: judging whether \hat{α}₀ is equal to π/2, if yes, ending the fractional domain noise reduction method, and if no, eliminating a recovered signal component xt xt−X_{\hat{α}}_{₀}uHu, and then repeating the steps S1 to S5 again until the optimal FRFT transform angle is equal to π/2; and
S6: applying the fractional domain noise reduction method to filter out a noise and to reserve features of the power signal in the power electronization power system,
wherein the original signal x(t) is a transient stationary disturbance signal or a transient non-stationary disturbance signal, and after steps S0- S6, a noise filtering and a retention of transient disturbance positioning information is realized for the original signal x(t).

2. The method according to claim 1,
wherein the fractional Fourier transform is defined as
$$\begin{matrix}{X}_{p} u & {\int }_{- ∞}^{∞} {K}_{p} & α ; u ; t & x & t & dt\end{matrix} \qquad ( 1 )$$
$${K}_{p} α ; u ; t = \{ \begin{matrix}\sqrt{\frac{1 - j cot α}{2 π}} \cdot {e}^{j ( \frac{{t}^{2} {u}^{2}}{2} cot α - ut csc α )} & α \neq n π \\ \begin{matrix}δ & t & u\end{matrix} & \begin{matrix}α & 2 n & 1 & π\end{matrix} \\ & \\ \begin{matrix}δ & t - u\end{matrix} & \begin{matrix}α & 2 n π\end{matrix}\end{matrix} \qquad ( 2 )$$
wherein p is an FRFT order, α is an included angle between an FRFT axis and a time axis, α=pπ/2, Kₚ(α; u; t) is a kernel function of fractional Fourier transform, δ( ) represents a unit impulse function, and n is an integer.

3. The method according to claim 2,
wherein the original signal x(t) is represented as
xt st d t nt (5)
wherein s(t) is a power frequency signal, d(t) is a transient disturbance signal, and n(t) is white Gaussian noise.

4. The method according to claim 3,
wherein a fractional spectrum fourth-order origin moment of the original signal x(t) is defined as
ηα∫_{-∞}^{∞}|X_{P}u|⁴du (10)
and then, the optimal FRFT transform angle \hat{α}₀ can be estimated as
$$\begin{matrix}{\hat{α}}_{0} & arg {max}_{α} η & α\end{matrix} . \qquad ( 11 )$$

5. The method according to claim 4, wherein
X_{\hat{α}}_{₀} u S_{\hat{α}}_{₀} u D_{\hat{α}}_{₀} u N_{\hat{α}}_{₀} u
where X_{\hat{α}}_{₀} u, S_{\hat{α}}_{₀} u, D_{\hat{α}}_{₀} and N_{\hat{α}}_{₀} u are the FRFT results of the original signal x(t), s(t), d(t) and n(t) at the optimal FRFT transform angle respectively.

6. The method according to claim 3,
wherein d(t) is a non-stationary transient disturbance signal,
d(t)=A·(u(t−t₁)−(t−t₂))·exp(j2πf₁t+jπkt²) (8)
wherein A is amplitude of the non-stationary transient disturbance signal, u(t) is a unit step signal, t₁ and t₂ are beginning and ending moments of the non-stationary transient disturbance signal, f1 is a beginning frequency of the non-stationary transient disturbance signal, and k is the modulation frequency thereof.

7. The method according to claim 1, wherein window functions used in the band-pass filtering include at least one of a rectangular window, a Hanning window, a Hamming window and a Blackman window.

8. The method according to claim 3, wherein an energy peak of the power frequency signal is less than an energy peak of the transient disturbance signal.
